(19) United States
(12) Patent Application Publication
(10) Pub. No.: US 2020/0071125 A1
(43) Pub. Date: Mar. 5, 2020

(54) CAMERA SYSTEM FOR REMOTELY MONITORING AN ELEVATOR CONTROLLER

(71) Applicant: Lift AI, LLC

(72) Inventors: Jerrod Kuhn, Ottawa Hills, OH (US); Robert J. Wurth, San Francisco, CA (US); Bruce Giese, Austin, TX (US)

(21) Appl. No.: 16/527,182

(22) Filed: Jul. 31, 2019

Related U.S. Application Data
(60) Provisional application No. 62/725,485, filed on Aug. 31, 2018.

(51) Int. Cl. B66B 5/00; B66B 1/34

(52) U.S. Cl. CPC B66B 5/0018; B66B 1/3461

(57) ABSTRACT

A system and method for remotely monitoring an elevator controller that controls an elevator, where the elevator controller includes one or more visual indicators of the status or operating mode of the elevator, such as LED indicator lights and an LCD display. The system includes an optical device, such as a digital camera, positioned to provide images of the visual indicators and a processor responsive to the images from the optical device. The processor processes and analyzes the images and provides processed data and other information of the operation of the elevator. A communications device transmits the processed data, and a remote application provided remotely from the elevator receives the processed data, which may include the images themselves or information identifying an elevator problem or other issue.

### CROSS-REFERENCE TO RELATED APPLICATIONS

This application claims the benefit of the filing date of U.S. Provisional Application Ser. No. 62/725,483, titled, System and Method for Remotely Monitoring Operation of an Elevator, filed Aug. 31, 2018.

### BACKGROUND

### Field

This disclosure relates generally to a system and method for remotely monitoring an elevator controller and, more particularly, to a camera system for remotely monitoring an elevator controller, where the camera system includes a camera that provides images of a display or other visual indicators on the controller and transmits the images to a remote application through the cloud and/or processes the images and sends data and information to the remote application through the cloud of the status and operation of the elevator.

### Discussion of the Related Art

Elevators are typically a crucial part of a building, especially a high rise building, in that they must operate to reliably and quickly move persons from floor to floor. If an elevator stops operating or has other performance issues it must be reported as soon as possible so that maintenance personnel can service the elevator and reduce user inconvenience. Typically, a non-operating elevator is reported to a building manager, who usually is not on-site, by a user of the elevator, where the building manager then contacts the maintenance personnel. Thus, there may be a significant lag time from when the elevator stops operating or is not operating properly to when the elevator is fixed. Also, there could be false reporting of a non-operating elevator, for example, if a user holds the elevator door open for an extended period of time, and the elevator is reported as non-operating by someone else. In that situation, the maintenance personnel could be called, but the elevator is actually working when he arrives to service it, referred to in the industry as running on arrival (ROA).

Elevators are controlled by elevator controllers typically located in a machine room proximate to the elevator. Elevator controllers come in variety of designs and capabilities depending on the elevator model, age, type, etc. Some modern elevator controllers have displays and other visual features, such as LCD displays, LEDs, etc., that provide a visual indication of the status and operational mode of the elevator. Those displays and visual features can identify various fault codes and other indicia identifying a specific problem or issue with the elevator, such as maintenance or service requirements, reasons for elevator shut-down, etc. However, in order to read the visual features, a technician or other personnel must be in the machine room where the controller is located to visually observe the controller, which adds time and inconvenience to fixing an improperly operating elevator.

### SUMMARY

The following discussion discloses and describes a system and method for remotely monitoring an elevator controller that controls an elevator, where the elevator controller includes one or more visual indicators of the status or operational mode of the elevator, such as LED indicator lights and an LCD display. The system includes an optical device, such as a digital camera, positioned to provide images of the visual indicators and a processor responsive to the images from the optical device. The processor processes and analyzes the images and provides processed data and other information of the operation of the elevator. A communications device transmits the processed data, and a remote application provided remotely from the elevator receives the processed data, which may include the images themselves and/or information identifying an elevator problem or other issue.

Additional features of the disclosure will become apparent from the following description and appended claims, taken in conjunction with the accompanying drawings.

### BRIEF DESCRIPTION OF THE DRAWINGS

FIG. 1 is a block diagram of an elevator system including an internet of things (IoT) box for processing sensor signals and sending elevator performance and shut-down warnings to a remote application and a camera system for remotely monitoring the operation of an elevator controller;

FIG. 2 is a block diagram of the IoT box separated from the elevator system; and

FIG. 3 is a block diagram of the camera system separated from the elevator system.

### DETAILED DESCRIPTION OF THE EMBODIMENTS

The following discussion of the embodiments of the disclosure directed to a system and method for using a camera to monitor the status and/or operation of an elevator controller and providing images or analyzed image data to a remote application is merely exemplary in nature, and is in no way intended to limit the invention or its applications or uses.

As will be discussed in detail below, this disclosure describes an elevator system that includes a number of sensors, processors, cameras and communications devices that monitor the operation of an elevator or bank of elevators and send notifications of actionable data to an owner, operator or user of the elevator at a remote location using, for example, a mobile application to allow the user to make informed decisions about the elevator. The system sends elevator shut-down warnings that notify the user that there is a certain degree of likelihood that an elevator is shut-down, where the warning explains why the elevator shut-down warning is being sent. The system allows the user to activate a running on arrival (ROA) watch via the remote application, where the user activates the ROA watch for a particular elevator by operating a button on the remote application. The remote application provides three types of information about the elevator, namely, the status as of activation, i.e., the last time the elevator ran, the number of floors the elevator moved to and the current location of the elevator in the hoistway; a historical event log, for example, number of rides, unexpected acceleration/deceleration of the elevator, an unexpected stopping location of the elevator, unexpected sounds, etc.; and a streaming event log, where the system provides streaming updates via text, or a similar manner, of all events subsequent to the ROA watch being activated by user.

The system can send user notifications that passengers are trapped in the elevator and send user notifications via the remote application that maintenance is required before the elevator breaks down (predictive maintenance), such as elevator or landing door performance is degrading and the elevator doors need to be serviced, elevator roller guides need to be serviced or replaced, ride quality is worsening and needs to be addressed, moisture is detected in the pit and the temperature in the machine room or hoistway is outside of specification. The system generates regular (e.g. monthly) elevator usage reports for resource optimization, where traffic analysis indicates how often the elevator is running, how often the elevator is broken down, what floors the elevator visits, how many trips the elevator takes, and the time of day the elevator is being used. The system also determines elevator usage per bank, specifically, whether the usage of the elevators within a bank of multiple elevators is distributed to share the load appropriately and the power consumption in the elevator machine room.

Elevators within a bank should have a consistent allocation of the overall number of trips for that bank, which can be monitored and provide an indication of a shut-down. The system determines that the elevator doors have opened or closed without elevator movement. Sounds in the elevator hoistway can be captured and an audio fingerprinting algorithm can be used to identify the sound of the elevator doors opening and closing. More specifically, elevator doors open and close before and after elevator movement such that if the elevator doors open and close repeatedly without the elevator moving, an indication of a shut-down can be given. The system uses sensor data to identify the locations within the hoistway where the elevator comes to rest, and those locations are logged. Since an elevator should consistently come to rest at the same location within the hoistway, an elevator at rest between logged locations indicates an elevator shut-down, and a shutdown warning can be initiated.

An ROA watch can be activated when a user presses a button on the remote application that increases the frequency of regular reports being sent for a particular elevator. An elevator's status as of activation is provided by sending the last time the elevator ran via the trip log, the number of floors the elevator moved to, and the current location of the elevator in the hoistway. A historical event log can be provided by sending the last ten events that occurred for the elevator, where an event includes a trip that is pulled from the trip log. An unexpected acceleration or deceleration of the elevator that is outside of an acceptable range of previous accelerations and decelerations for that elevator is an indication of the elevator stopping at a location other than one of the normal resting places for the elevator, or a sound that is deemed inconsistent with the normal audio fingerprint of the elevator. The system also can include a streaming event log, where for a predetermined period of time (e.g. 10 minutes), the user receives real-time text messages of any events associated with the elevator.

Audio fingerprinting can be employed where the system collects audio signals during the time immediately before and immediately after a usage trip and applies audio signal processing to create a distinct signature for the audio in order to find common repeating patterns corresponding to the sound of the doors opening and closing occurring frequently (but not always) in the time periods. A common signature occurs within the time before the beginning of a large portion of elevator trips, which corresponds to the doors opening. Similarly, a common signature occurs within the time after the end of a large portion of the elevator trips, which corresponds to the doors closing. Based on these patterns, the system is able to detect at any time when the elevator doors open and close with a high degree of accuracy.

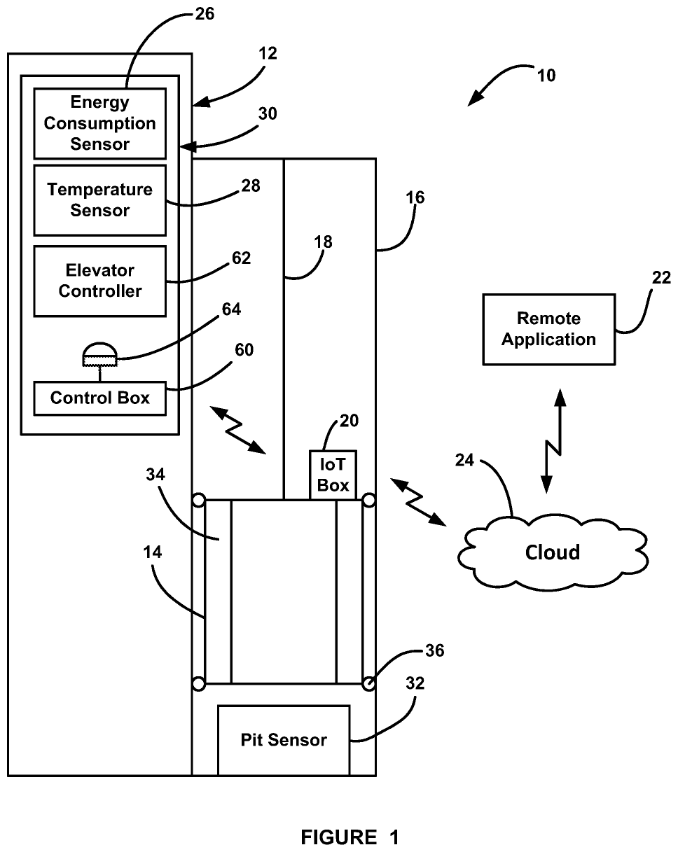

FIG. 1 is a block diagram of an elevator system 10 that provides the features discussed to above and is part of, for example, a building 12, such as an office building, apartment building, etc. The elevator system 10 includes an elevator 14 traveling in a hoistway 16 on roller guides 36 by operation of a cable 18 between building floors in the usual manner, and could be part of a bank of elevators, where the elevator 14 includes elevator doors 34. An internet of things (IoT) box 20 is mounted to the elevator 14 generally by being screwed or taped to a top panel of the elevator 14 and, as will be discussed in detail below, provides data, information, measurements, etc. to a remote application 22 through a network cloud 24, where software on the cloud 24 can analyze the data before it is sent to the remote application 22. The remote application 22 can be operating on any suitable device or devices for the purposes described herein, such as a smart phone, tablet, desktop computer, and/or another device that can run a certain application and alert or provide status of elevator operation to a certain entity, such as a property owner, property manager, elevator service company, or another supervising party or machine. The data sent to the remote application can be in any suitable form and displayed on the application in any suitable format, such as text or images.

A machine room 30 is generally provided in the building 12, typically close to the elevator 14, where various hardware and devices relating to the operation of the elevator 14 and possibly other systems in the building 12 are contained including an elevator controller 62 that controls the operation of the elevator 14. An energy consumption sensor 26 that provides elevator energy consumption information to the box 20 and a temperature sensor 28 that provides elevator temperature measurement signals to the box 20 are also located in the machine room 30. A camera 64 is also located in the machine room 30 and is directed towards the controller 62. The camera 64 sends images of the controller 62 to a control box 60 to illustrate fault codes, warning lights, displays, etc. on the controller 62, as will be discussed in detail below. The control box 60 processes the images and sends the images and/or other data relating thereto to the remote application 22 through the cloud 24 and/or to the remote application 22 through the box 20 and the cloud 24. Also, a pit sensor 32 is positioned at the bottom of the hoistway 16 that provides moisture detection signals to the IoT box 20.

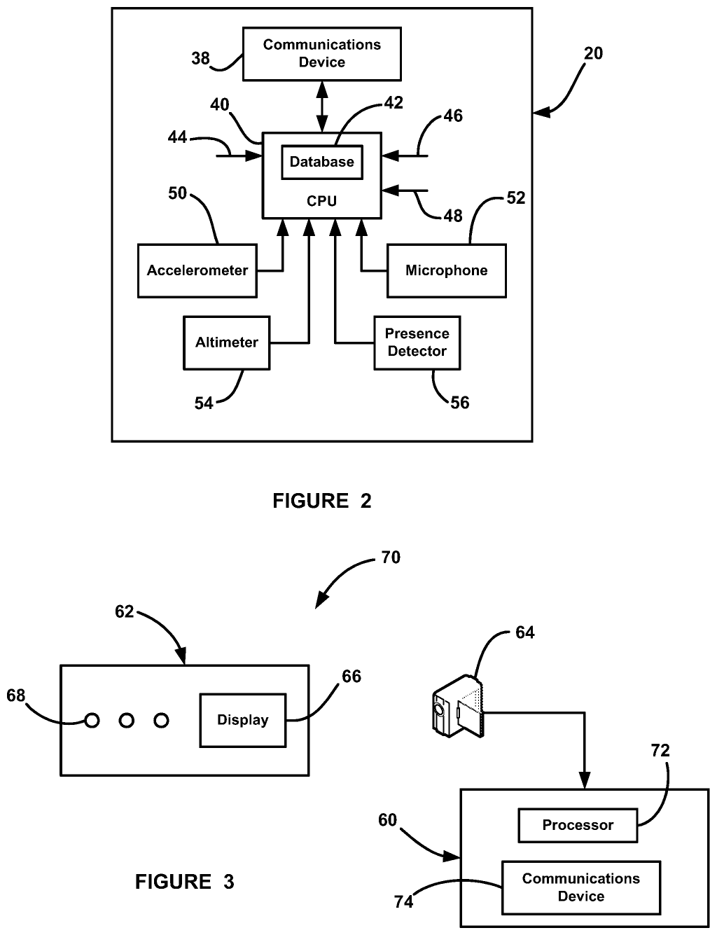

FIG. 2 is a block diagram of the IoT box 20 separated from the system 10 that includes a central processing unit (CPU) 40 having a database 42 and that operates many of the algorithms and processes discussed herein. The box 20 includes a communications device 38 that allows the box 20 to communicate with the cloud 24, and may include one or more of a cellular modem, an Ethernet connection, Bluetooth capability, a wireless LAN adapter, etc. The box 20 receives the energy consumption signals from the sensor 26 on line 44, the temperature signals from the sensor 28 on line 46, and the moisture signals from the sensor 32 on line 48. If any of these signals are outside of a normal predetermined range, the CPU 40 can send a warning signal to the remote application 22 for service.

The IoT box 20 also includes an accelerometer 50 that detects movement of the elevator 14 and sends elevator movement data to the CPU 40. The CPU 40 can use this data in connection with a historical look-back feature to determine the probability that the elevator 14 is shut-down. For this feature, an algorithm operating in the CPU 40 uses the movement data to determine that a trip has occurred each time the elevator 14 starts and stops moving, and logs the trips for the elevator 14 in the database 42 with a timestamp. The algorithm creates a historical log of the number of the trips during a given time period (e.g. one hour) on a given day of the week (e.g. Saturday) and compares the number of trips for the elevator 14 in the “current” time period to the expected number of trips on the same day of the week and time from the historical log. For example, the algorithm may determine that there were zero trips today, Tuesday, between 8 am and 10 am, and at least fifty trips on each of the last ten Tuesdays between 8 am and 10 am. If the number of the trips during the current time period is significantly different, i.e., outside of a predetermined percentage, than the previous same time period an elevator shut-down has likely occurred, and a shut-down warning is sent to the remote application 22. The user sees the notification on the remote application 22 and ensures the elevator 14 receives service.

The IoT box 20 also includes a microphone 52 that detects sounds in and around the elevator 14, and those sounds can be used to determine whether the elevator doors 34 are opening and closing without the elevator 14 moving. More particularly, the microphone 52 captures sounds in the elevator hoistway 16 and sends audio files of the sounds to the CPU 40, where an algorithm operating in the CPU 40 converts the audio files into audio fingerprints that connect a certain sound to a certain thing. Since the elevator doors 34 make a consistent sound when they open and close, the algorithm can categorize which of the audio fingerprints are the elevator doors 34 opening and closing. By using data from the accelerometer 50 indicating elevator movement over time, the algorithm can determine if the elevator doors 34 are being repeatedly opened and closed without the elevator 14 moving during the same time period, which is an indication of a shut-down. A shut-down warning can be sent to the remote application 22.

The system 10 can also use the audio fingerprints generated from the audio files from the microphone 52 of the doors 34 opening and closing to determine elevator door opening performance. Specifically, since the CPU 40 can categorize the audio fingerprints of the elevator doors 34 opening and closing, currently collected audio fingerprints of the elevator doors 34 opening and closing can be compared to previously collected audio fingerprints of the elevator doors 34 opening and closing, where a significant enough difference therebetween may be an indication that the elevator doors 34 are degrading or not operating properly.

The IoT box 20 also includes an altimeter 54 that detects the pressure of the air surrounding the elevator 14 at a given point in time and sends the air pressure data to the CPU 40. An algorithm operating in the CPU 40 calculates the altitude of the elevator 14 based on the air pressure to identify the location of the elevator 14, and thus the CPU 40 can generate a log of the locations where the elevator 14 regularly stops. Since the elevator 14 should only stop at the elevator landings within the building, if the elevator 14 stops at an altitude that is not at an elevator landing, this is an indication that the elevator 34 is not operating properly. The algorithm compares the location where the elevator 14 has stopped to the locations where the elevator 14 should stop, and if those locations do not match, the algorithm assigns a likelihood that the elevator 14 is not operating properly and should be shut-down, which is transmitted to the remote application 22.

The location of the elevator 14 in the hoistway 16 can also be determined by using the data from the accelerometer 50. As discussed, the accelerometer 50 detects movement of the elevator 14 over time and sends the elevator movement data to the CPU 40. An algorithm operating in the CPU 40 uses the movement data to determine the speed at which the elevator 14 has moved and the time it took to move to determine at what location in the elevator hoistway 16 the elevator 14 is stopped. The algorithm logs the locations in the elevator hoistway 16 where the elevator 14 stops regularly, where the elevator 14 should only stop at elevator landings within the building 12. If the elevator 14 stops at another location, it is an indication of a shut-down. The algorithm compares the location where the elevator 14 has stopped to the locations where the elevator 14 should stop, and if those locations do not match, the algorithm assigns a likelihood that the elevator 14 is not operating properly and should be shut-down, which is transmitted to the remote application 22. Both of these elevator location techniques can be combined to more accurately determine whether an elevator shut-down event is occurring.

The IoT box 20 also includes a presence sensor 56, such as an optical sensor, a camera, a thermal detector, etc., that sends signals to the CPU 40 that can be used to detect the presence of a person in the elevator 14. An algorithm operating in the CPU 40 uses the data to determine the likelihood that a person is entrapped in the elevator 14 when a shut-down warning is given for any of the shut-down detection techniques discussed herein. If the algorithm indicates that it is likely that a person is in the elevator 14 at the same time that a shut-down warning has been generated, the CPU 40 also sends an entrapment warning to the remote application 22.

The system 10 also includes a live event log feature. A user can press a button on the remote application 22 so that it sends a message to the CPU 40 to increase the type and frequency of the notifications and reports sent to the remote application 22 concerning elevator activity. Those notifications and reports can include when the elevator 14 moves using the accelerometer data, where the elevator moved from and to using the accelerometer and altimeter data, elevator door opening and closing information using the microphone data, the elevator's current position using an algorithm processing the altimeter and/or accelerometer data, etc. All of the information can be provided in real-time about the elevator's subsequent activity for a time period determined by the user.

The system 10 can also use the sounds in the elevator hoistway 16 captured by the microphone 52 to determine elevator ride quality as provided by the elevator roller guides 36. The microphone 52 sends the audio files of the sounds captured in the elevator hoistway 16 to the CPU 40, and an algorithm operating in the CPU 40 converts the audio files into audio fingerprints. Since the elevator roller guides 36 make a consistent sound at a given location in the elevator hoistway 16, the CPU 40 can categorize certain ones of the audio fingerprints as the sound of the elevator roller guides 36. The accelerometer 50 determines the elevator's movement over time and sends the elevator movement data to the CPU 40. The algorithm uses the audio fingerprints of the elevator roller guides 36 during a normal operation and the location of the elevator 14 in the elevator hoistway 16 to determine the audio fingerprint of the elevator roller guides 36 at certain locations in the elevator hoistway 16. The algorithm compares the audio fingerprints of the sounds that occur at certain locations in the elevator hoistway 16 to the audio fingerprints of the elevator roller guides 36 in normal operation at certain locations in the elevator hoistway 16. If the audio fingerprints are inconsistent and outside of some predetermined percentage, the CPU 40 determines the likelihood of a roller guide ride quality issue, and notifies the remote application 22 accordingly. In an alternate embodiment, audio pattern recognition, i.e., vertical and horizontal line recognition in a spectrogram, can be used instead of audio fingerprints.

Ride quality can also be determined based on vibration. In this embodiment, the accelerometer 50 detects vibrational movement on the elevator 14 and sends vibrational data to the CPU 40. An algorithm operating in the CPU 40 determines the normal amount of vibrational movement on the elevator 14 and compares the detected vibrational movement data to the normal vibrational data, such that if the vibrational movement exceeds the normal amount by a certain percent, the CPU 40 sends a ride quality warning to the remote application 22.

As shown in FIG. 3, the elevator controller 62, the control box 60 and the camera 64 combine to make up a system 70 for remotely monitoring the operation of the elevator controller 62. The controller 62 is intended to represent any elevator controller that provides visual indications of the operation and status of the elevator 14 and the camera 64 is intended to represent any optical device suitable for the purposes discussed herein. In this embodiment, the controller 62 includes an LCD display 66 and LED indictor lights 68, but may also include other visual indicators of the operation of the elevator 14. The display 66 and the lights 68 may provide an indication, such as fault codes, of the status, operating mode, service requirements, etc. of the elevator 14, which can be used to identify any problems or other issues with the elevator 14.

The camera 64 is directed at the display 66 and the lights 68 and takes video or other types of images, including digital images of the display 66 and the lights 68. Those images are sent to a processor 72 within the control box 60, which includes embedded software for analyzing the video and/or images consistent with the discussion herein. The camera 64 can send the images to the processor 72 by any suitable wired or wireless connection. The processor 72 can determine elevator performance based on the images or video, can convert fault codes or other indicators into information about elevator performance, can convert the images into fault indicators, etc. The processor 72 provides the analyzed image data to a communications device 74 in the control box 60 that transmits the data to the remote application 22 through the cloud 24, where the communications device 74 may include one or more of a cellular modem, an Ethernet connection, Bluetooth capability, a wireless LAN adapter, etc. Alternately, or in addition to, the image data transmitted by the communications device 74 can be sent to the communications device 38 to be stored in the database 42 and be processed by the CPU 40, where the communications device 38 may send the image data to the remote application 22 through the cloud 24.

The image data provided by the processor 72 can be in any suitable format or protocol for a particular elevator system, such as the raw images from the camera 64, textual information identifying a specific elevator problem, specific fault codes, etc. that can then be looked at by the user of the remote application 22, who can then take the necessary steps, if any. The data and images can be stored at any suitable location, such as in the processor 72, in the database 42, in the cloud 24 or on the remote application 22.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A system for remotely monitoring an elevator controller that controls an elevator, said elevator controller including one or more visual indicators of a status or operational mode of the elevator, said system comprising:
an optical device positioned to provide images of the visual indicators;
a processor responsive to the images from the optical device, said processor processing and analyzing the images and providing processed image data of the images;
a communications device responsive to the processed image data and transmitting the processed image data; and
a remote application provided remotely from the elevator and receiving the processed image data.

2. The system according to claim 1 wherein the elevator controller, the camera, the processor and the communications device are located in a machine room.

3. The system according to claim 1 wherein the optical device is a camera.

4. The system according to claim 3 wherein the camera provides digital images and/or digital video.

5. The system according to claim 1 wherein the communications device includes one or more of a cellular modem, an Ethernet connection, Bluetooth capability and a wireless LAN adapter.

6. The system according to claim 1 wherein the visual indicators include LED lights and/or an LCD display.

7. The system according to claim 1 wherein the visual indicators provide fault code information.

8. The system according to claim 1 wherein the communications device transmits the images.

9. The system according to claim 1 wherein the communications device transmits image data identifying an elevator problem.

10. The system according to claim 1 wherein the remote application is a mobile application.

11. The system according to claim 1 wherein the remote application is operating on a smart phone, a tablet and/or a desktop computer.

12. The system according to claim 1 further comprising an elevator monitoring box mounted to the elevator, said elevator monitoring box including one or more sensors for monitoring the operation of the elevator, said elevator monitoring box receiving the processed image data from the communications device and sending the image data to the remote application.

13. The system according to claim 12 wherein the sensors include one or more of an altimeter, a microphone, an accelerometer and a presence detector.

14. A system for remotely monitoring an elevator controller that controls an elevator, said elevator controller including one or more visual indicators of a status or operational mode of the elevator, said system comprising:
a camera providing digital images and/or video of the visual indicators;
a processor responsive to the images and/or video from the camera, said processor processing and analyzing the images and/or video and providing processed image data of the images and/or video;
a communications device responsive to the processed image data and transmitting the processed image data, wherein the elevator controller, the camera, the processor and the communications device are located in a machine room proximate to the elevator; and
a remote mobile application provided remotely from the elevator and receiving the processed image data.

15. The system according to claim 14 wherein the visual indicators include LED lights and/or an LCD display.

16. The system according to claim 14 further comprising an elevator monitoring box mounted to the elevator, said elevator monitoring box including one or more sensors for monitoring the operation of the elevator, said elevator monitoring box receiving the processed image data from the communications device and sending the image data to the remote application.

17. The system according to claim 16 wherein the sensors include one or more of an altimeter, a microphone, an accelerometer and a presence detector.

18. A method for remotely monitoring an elevator controller that controls an elevator, said elevator controller including one or more visual indicators of a status or operational mode of the elevator, said method comprising:
providing images and/or video of the visual indicators;
processing and analyzing the images and/or video to provide processed image data of the images and/or video; and
transmitting the processed image data to a remote application provided remotely from the elevator.

19. The method according to claim 18 wherein the elevator controller is located in a machine room proximate to the elevator, and wherein providing images and/or video, processing and analyzing the images and/or video and transmitting the processed image data occurs in the machine room.

20. The method according to claim 18 wherein the visual indicators include LED lights and/or an LCD display.
